(19) United States
(12) Patent Application Publication
(10) Pub. No.: US 2015/0106138 A1
(43) Pub. Date: Apr. 16, 2015

(54) Power transferred by electrical conductors for gas lighter than air inflatable balloons and apparatus with neutral buoyancy maintained by weight adjustable printed material that protects customers and profitably for businesses with software process innovations

(71) Applicant: Larry F. Fisher, North Bend, OR (US)

(72) Inventor: Larry F. Fisher, North Bend, OR (US)

(73) Assignee: Hub of WebMobile, Inc., Coos Bay, OR (US)

(21) Appl. No.: 13/999,162

(22) Filed: Jan. 21, 2014

Related U.S. Application Data
(60) Provisional application No. 61/849,271, filed on Jan. 22, 2013.
(60) Provisional application No. 61/850,990, filed on Feb. 26, 2013.
(60) Provisional application No. 61/851,965, filed on Mar. 13, 2013.

(51) Int. Cl. B64B 1/40; G09F 21/08; G09F 7/18; G06Q 10/06; G08C 23/04

(52) U.S. Cl. CPC B64B 1/40; G06Q 10/063; G08C 23/04; G09F 7/18; G09F 21/08; G09F 2007/1865
USPC 705/7.11; 398/106; 307/147; 244/31

(57) ABSTRACT

Power transferred by electrical conductors for gas lighter than air inflatable balloons and apparatus with neutral buoyancy maintained by weight adjustable printed material that protects customers and profitably for businesses with software process innovations.

### RELATED APPLICATION

This application claims the benefit of U.S. Provisional Applications No. 61/849,271 filed Jan. 22, 2013 and the benefit of U.S. Provisional Application No. 61/850, 990 filed Feb. 26, 2013 and the benefit of U.S. Provisional Application No. 61/851,965 filed Mar. 13, 2013.

### BACKGROUND OF THE INVENTION

The present invention is a gas lighter-than-air inflated balloon achieving neutral buoyancy as it is related to attached weight adjustable printed material that contains rewards related to businesses or organizations and customers and on which a portion is coded and informational to be advanced to the unique computer embodied software process to profitably protect customers. And the devices can be uniquely connected to and by a signal and electrical and apparatus with components.

Prior art to achieve neutral buoyancy on balloons and tethered to keep it from escaping was as far back as May 1932 U.S. Pat. No. 1,858,460 to Ranseen. It is known to use a lighter-than-air gas to counterbalance the weight of an encompassing structure to produce a balloon which is substantially weightless. There have been various inventions attaching adjustable ballast to the skin of the balloon envelope using pressure sensitive adhesive attached weights. A patent claims the use of pressure sensitive hook and loop on the skin of the balloon. One patent uses a long length of string which is at some point too heavy to be lifted any further so the balloon is held suspended above a table tops desired display position for decoration settings.

Currently there are a number of solutions for a helium balloon achieving neutral buoyancy with weight adjustments. Some solutions were attempts to function as envisioned, but these solutions failed to meet the needs of the industry because they were not practical in their attempt to adjust the neutral buoyancy with individual weights being each too heavy and not with an easy and fine enough adjustability. Other solutions attempt to hold the balloon in positions resembling a flying saucer or space ship but they exceed minimum gross weight performance and were not successful. This limits balloon size and length of time the product can be enjoyed. It is apparent that these inventions obviously did not meet industry acceptance.

There were other products with similar intent, and those were even less likely to have ever been successfully marketed because they were impractical given the material with which they employed. Other solutions are deficient, missing, lacking, insufficient, undesirable and or inferior about that which are similar, but albeit inferior solutions.

There have not been any neutral buoyancy balloon products related to a weight adjustable printed material nor then it leading to the needs of advertising via web site software designed software structure and organization to greatly advance the ability for business to enhance products as they relate to customer satisfaction and business profitability.

### SUMMARY

The invention comprises s a gas lighter-than-air inflated balloon achieving neutral buoyancy as it is related to attached weight-adjustable-printed-material that contains rewards from advertisers as example related to businesses or organizations and customers and on which a portion is coded and informational to be advanced to the unique computer embodied software process to protect customers and improve associated businesses profitability. Also this apparatus comprises devices uniquely connected to and by signal and electrical and mechanical components.

The present invention is unique when compared with other known devices and solutions because the present invention provides a realistic means to control the neutral buoyancy of a balloon easily and being in control by the use of the weight adjustable printed material.

Another advantage over previous inventions occurs with the present invention uniquely when locating power to any place on inside or outside surfaces of balloons and apparatuses most particularly when they are electrically isolated as determined suitable for this purpose when manufactured and compared with other known devices because is the only invention that can pass electrical current to desired locations in the balloon or on the outside of the balloon or to balloon related attachments, so it can provide power to at least IR and electro mechanical and other devices. In this invention the electrical conductors appear obscure. The battery power can be installed or attached or located possibly at the base of the balloon either inside or outside of a balloon or at other desirable locations.

Additional improvements over previous inventions are seen in this invention as the outside of the balloon can be manufactured with conductive surfaces exposed to permit electrical contacts to be made. There are various ways to comprise the electrical connection between electro mechanical devices and the conductive means.

The present invention is also unique from others when the electrical conductor material passes into the balloon and other conductive materials could be used in addition to the example stated here within. A critical issue here is to not interfere with or interrupt the flow of electricity and do so while not developing a space or opening for the escape of the helium or lighter than air gas. One means for solving these issues is to make the conductors thin as is the balloon metalized foil material and covering it thinly to electrically isolate the inner conductive material. While also making it narrow. The commonly used general design of the clear film filling valve for the Mylar type balloons has open flaps on both sides of the filling tube as part of the heat sealing manufacturing process. The thin and narrow conductors could be inserted in the open flaps by which the conductors can enter or exit the inside of the balloon and the balloon remains leak free as the manufacturing process can seal these conductors in place.

The length of the conductors can be determined by design needs and if the outside of the balloon served in some way as a conductor only one entering or exiting might be necessary.

In the balloon manufacturing process electrical contact points can be established around the inside or outside edges of the balloon. Circuit boards and batteries can be attached to the inner or outer surfaces and also to the surfaces of attached features as described in this invention or switching as could be demonstrated with a remote control signal device or an Infrared device which are also part of this invention.

Similarly, the associated method is unique in that it: The weight adjustable printed material serves simultaneously two important purposes. One without the other will lessen intent of this invention. When a piece of the printed material is removed to adjust the neutral buoyancy of the balloon height the printed material also then serves the purchaser with a means to enter the computer software via the web and any mobile apps and sign in for rewards and share their balloon related photos and messaging as prescribe preferably on more than one or each separate piece of the printed weight adjustable material. So, as the days go by the neutral buoyancy adjustment is required to keep the balloon at the desired height and the new printed material to accomplish this is removed and the information it contains is entered into the company's website for more associated benefits from various participants in this process which can last for weeks and months particularly when the purchaser takes the balloon back to the place of purchase or a participating dealer for a gas refill and a purchase of another pack of the weight adjustable printed material which will cycle the purchaser into further benefits on the company website and the important software program that secures positive outcomes for and from all the possible combinations of multiple participators in this method of business.

The current use of Smart Phones and Apps written for this invention coupled with the unique and special software as described previously and the scan ability of the present technology of QR Codes enables the Company and the Customer and the Corporate and NGO as example vendors to more firmly enable the business method of this invention. The use of QR Codes techniques to product or packaging to pass or exchange remote data and information on any balloon products is a part and only one example of weight adjustable printed material and a important piece to the customer and corporate vendors necessary to the unique software and customer satisfaction and consequently product sales. Included but not limited to any software embedded electronic device for the purpose of reading, or translating, or transferring, or informing, any such device to enable convenience or education or business advantages or any other means on balloon products or packaging or its content as herein described to protect the inventions business method.

The software of the present invention is unique when compared with other known solutions in that it provides unique functions by designing a cross checking of all the various participants so as to protect all participants from unmeasured and uncontrolled participation becoming sufficient to defeat positive outcomes for all businesses and resulting in high quality customer service and satisfaction, which is the desired and necessary measureable and controllable outcomes for success of this unique software process.

Serving customers is paramount to a company's long term financial success. The unique process in this invention software will more profitably provide superior service to customers and thus gaining more customers.

This is a unique fundamental business process between a customer acquiring a product or service or other types of transactions as examples from a company or organization.

This first primary company is or can be a Balloon process that has signed up to use this unique software because superior customer service is profitable. This unique software may also necessarily serve the weight adjustable printed material element of this process in this invention. The advertisers that purchase add space as example on the weight adjustable printed material for customer's rewards and services and items of interest for the customers that purchase in this instance the Balloon related devices or products.

The software process use requires that a primary company that is being one that made the product available to potential customers and requires the product supporting businesses will also be signed up together to use this same software together. All these business are responsible for supporting the product purchased by the customer. They will through the software also simultaneously support the customers purchasing or interests in this services or products or line of same.

The customers enter the web site and enter this unique software process to the product's primary business software and simultaneously the support businesses of this product or product line. Therefore the customer can be served by the primary business and the supporting businesses. All the business associated with this product or product line can also exchange information and support among themselves to always be capable of better serving the customers.

The customer service information can be made available to other customers interested in the results of the service received via this unique software process. Other primary businesses or organizations can sign up for this unique software service when they are interested in open and clear superior customer service.

This software process serves the needs of many businesses and organizations and their customers or recipients because it opens for all participants including customers, primary businesses and support businesses and future purchasers of the balloon product or any other products or companies or organizations a clear and open view their purchases and customer service and quality of products and sources of products materials are now all available to the consumer.

This process and the unique software benefits the businesses in this new open relationship with customers, because the business has open access to customer information that was costly to secure int the previous decades business model. Now business can ask customers for a large amount of personal detail related to interests, transactions, place of purchase, what they like and not like, what do they want to see changed, do they share with friends, and followers, and other helpful information for businesses

This unique software provides a winning relationship between business and their customers. This process opens the door to collaboration between customers and employees of all the businesses that take part in providing a product to a local shelf. These supporting businesses concentrically support each other's customer service and subsequently control customer satisfaction. This unique software builds greater profitability by improving brand loyalty by this unique software structure and process.

The current business model of the last century has existing limits and it is the intention of this invention to provide a superior and unique process to serve the needs of the balloon product and any other businesses that desire to obtain access by subscription the use of this unique software that has not previous been invented.

To accomplish this desired outcome, product and software, first a balloon product has a unique ID that includes the zip code of the purchaser/customer. This complete product code and with some customer basic participatory information and social media contacts is entered into the well-designed company web page by the purchaser.

At this point the customer's product ID code containing the zip code can be released to participating companies, organizations, and others all referred to in pieces of the “weight adjustable printed material”.

When the customer adjusts the balloon height and later sign into the company web site with another and different company's benefit piece the customer is connected to the business that is providing the “benefit”. The originating company product web mobile site permits this contact to be made and by Smart Phone unique application software and generally referred to as Apps and as they apply to all devices as they are not substituting for operating systems and unique QR Code data and features to become a necessary piece of the invention.

And tracts this process and the number of times each customer has follow ups with the benefit providing business and the number of returns and length of times and when they are occurring with each individual customer.

Ultimately, the goal is to measure and control all outcomes for all participants, (Support Companies) through simultaneous contacts. The measured outcomes will benefit the product providing company. This is most important and this software will be modified even further so that the process is a social business interaction.

Any portion of this entire process in 20 countries and millions of customers a year will only work satisfactorily if all participants are successfully served. No business software is adjusting profitability in such a contractual manner.

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 is a perspective view of a gas lighter than air inflated balloon comprising of Mylar, latex, bubble type embodying the present invention.

FIG. 2 is a sectional view of the of the device shown in FIG. 1

FIG. 3 is a view of the device with two additional apparatus.

FIG. 4 is a view of a concentric software structural relationship for businesses pleasing customers and fellow businesses more profitably.

FIG. 5 is a larger view of the Customer's Hub drawing found in FIG. 4.

### DETAILED DESCRIPTION OF THE PREFERRED EMBODIMENTS

A Balloon inflated with lighter than air gas and comprising an apparatus attached with weight adjustable printed material comprising: By either adding more weight adjustable printed material to apparatus or removing some weight adjustable printed material from the apparatus until neutral buoyancy is achieved. As weight adjustable printed material is removed to adjust for neutral buoyancy then the product owner proceeds with that piece to unique software process to respond to business provided opportunities as stated to inquire about on the weight adjustable printed material.

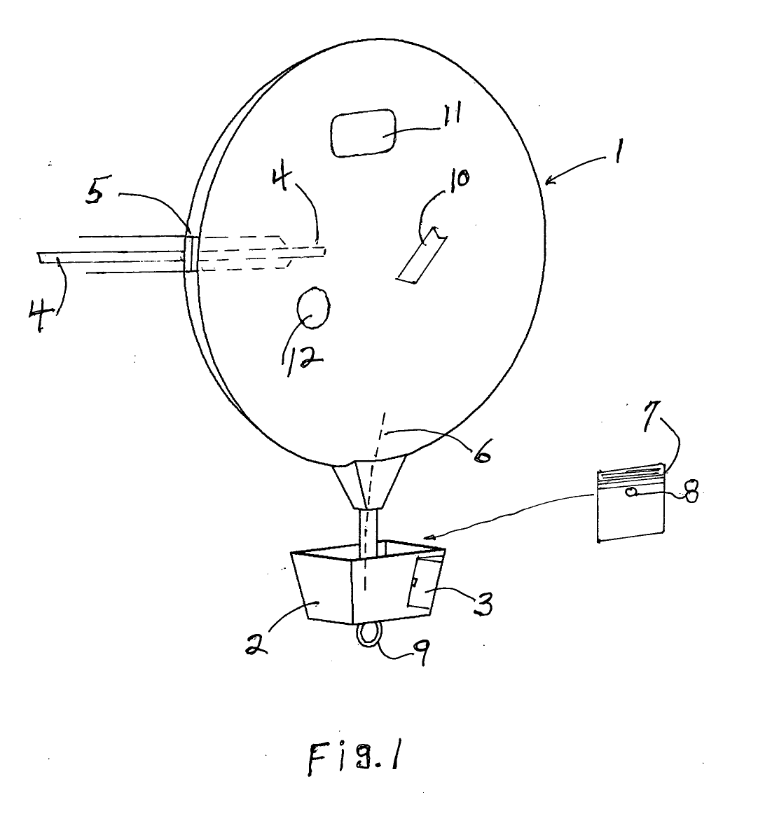

Referring now to the drawings which form a part of the disclosure herein, and with particular reference to FIGS. 1-5 an apparatus in the form of balloon inflated with lighter than air gas noted generally at 1 which includes a 2 gondola, and gondola with 3 device, power, and apparatus capability, a 4 conductor through 5 sealed edge, a 6 conductor internal, 7 one or more weight adjustable printed material that is 8 hole drilled, a 9 tie down ring, a 10 space on Mylar balloon exposing conductive surface, and surfaces foil free windows for 11 frequencies access and 12 for viewing into balloon.

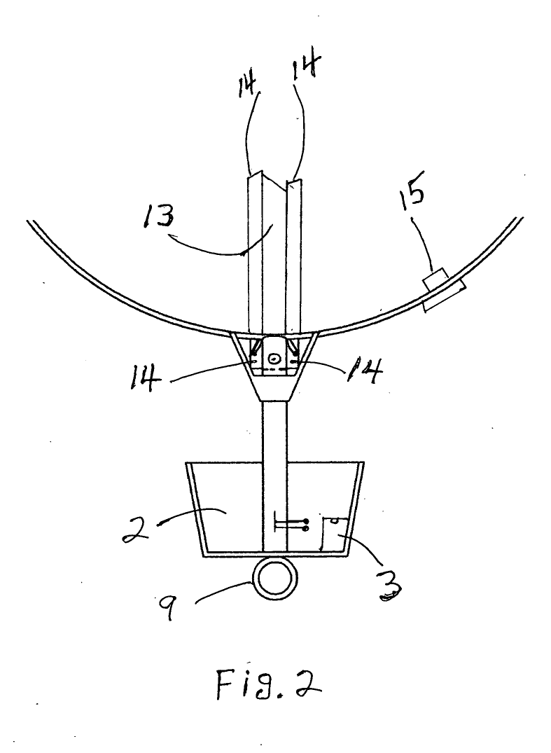

Referring now to FIGS. 2 as in addition a 13 gas fill tube for inflation or exhaust, a pair of 14 marginal conductors, and 15 magnetic material attachable to inside wall side.

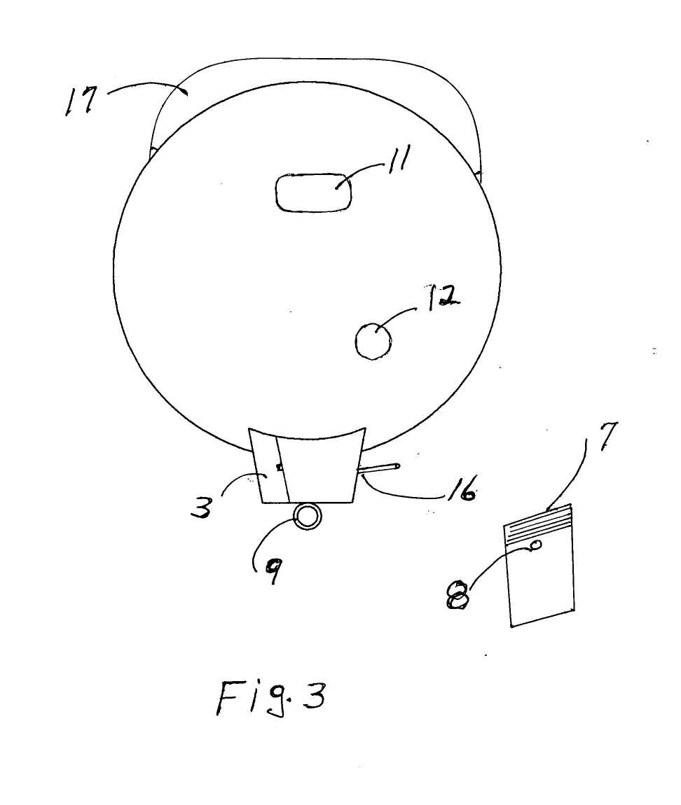

Referring to FIG. 3 an apparatus attached near balloon base, 16 post to hang weight adjustable printed material, 17 draft sail attachable to outside surface of balloon or to apparatuses.

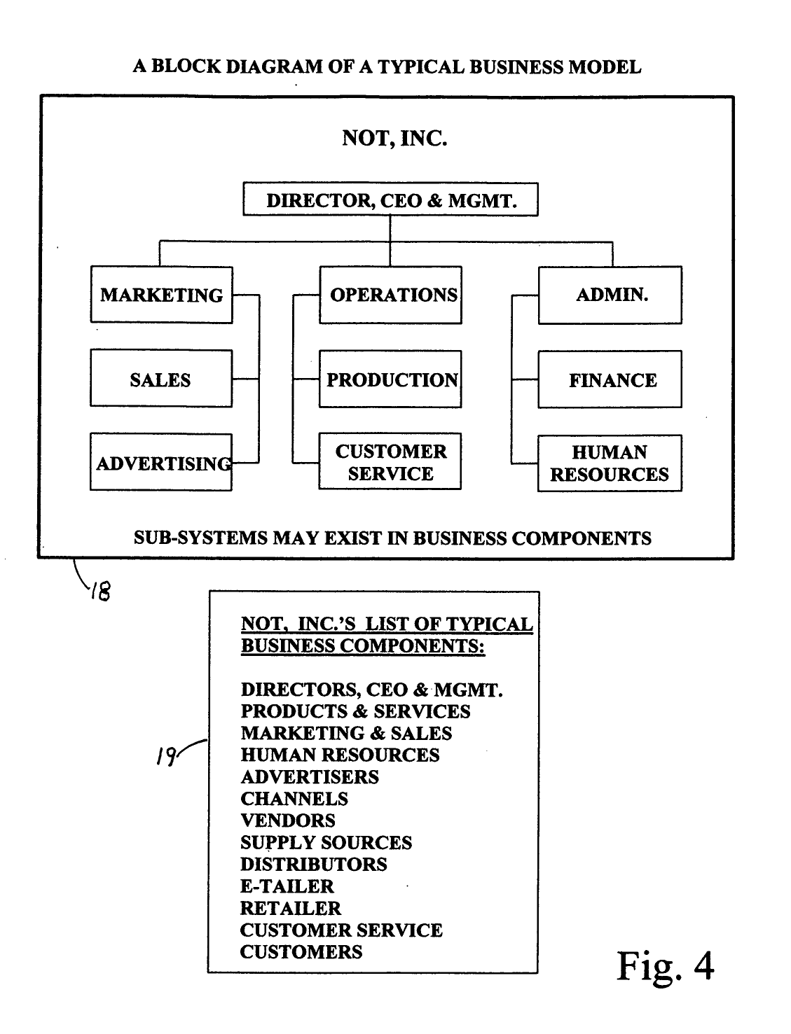

Referring to FIG. 4 is a 18 typical business block diagram of the typical components, followed by 19 is the Typical Components List , as indicated to invert the list and resulting with 20 as the Enabling Components List, and shown 21 is a change from 18 to a unique business process that will concentrically advantage customers being place in the center of collaborative customer service.

Other embodiments of the invention are shown with particular reference to FIG. 4 as one implementation of the invention as an application of the business process as it supports the product purchase and customer service and product and business development through software that is the only business process that functionally can fully focus the entire business organization on their customers and their customers can simultaneously collaborate back with all components of the business organization. This software process is a competitive advantage for the business components and provides business with superior control over customer service satisfaction.

Referring to FIG. 4 it is shown in the 21 drawing the series of arrowed line. These all indicate the lines of communication and collaboration of the full Enabling Components List. Business #6 is the Primary Business that subscribed for the software and is introducing a balloon product line to the public. In this software process the Primary Business or organization is the position that initiates the subscription by the Corporate Managers.

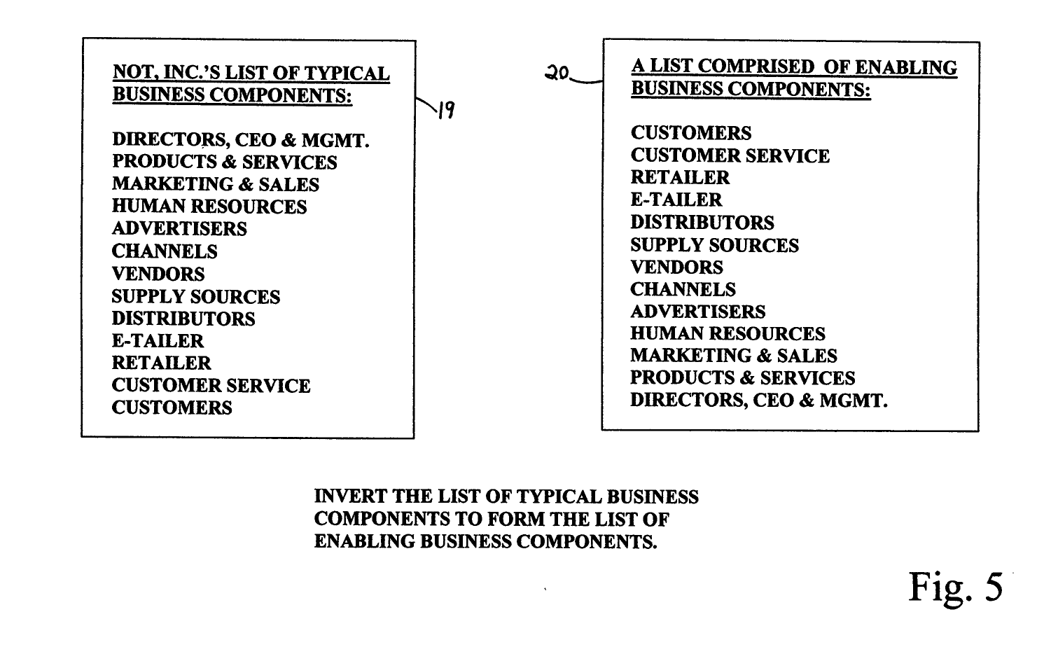

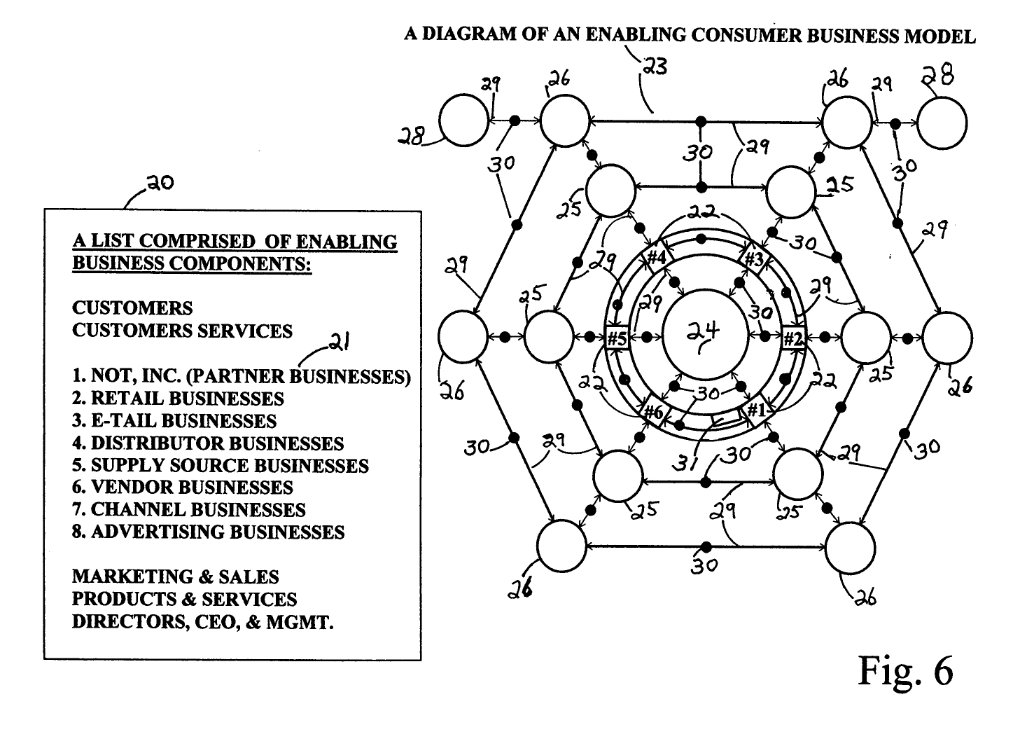

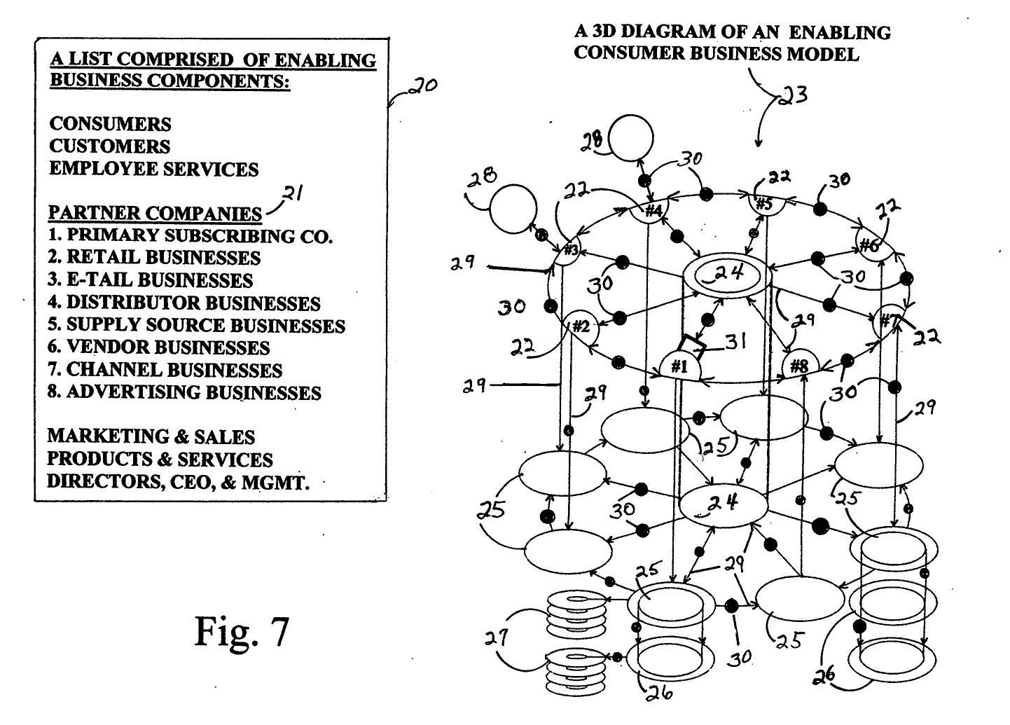

Referring to FIG. 5 is an enlarged view of 21 for clarity.

What is claimed is:

1. A Balloon inflated with lighter than air gas and achieving neutral buoyancy with weight adjustable printed material that is comprising an apparatus attached with the weight adjustable printed material attached to said balloon comprising:
(a) said weight adjustable printed material is comprised of for more pieces of material
(b) said weight adjustable printed material is comprised of marked, differently cut or shaped, colored, information, rewards, numbering or lettering unique combinations, scanning codes, manufactured designs, colors, or any combinations of different colors or patterns in any number of pieces or shapes or sizes.
(c) apparatus to which said weight adjustable printed material is attached comprises in one version a plastic container or clamping device with a magnetically attracted surface.

2. The weight adjustable printed material comprises in one means printed advertisements or sponsored rewards, points of interest, balloon products and support, unique codes and directions to consumer to access to unique customer protective concentric software process comprising of customer service with product sellers and all services providers available to customers comprising Business to Businesses and Business to Consumers.

3. The software process and method to protect customers and for obtaining data and arranging and optimizing customer's satisfaction and to optimize business profitability comprising:
(a) Software process structure comprised of inverting the list of typical business components as taken from a conventional business organizational block diagram.
(b) Said list is inverted organizationally as first step to enable the component list for next software process requirement.
(c) Software process inverts conventional business list of components and then organizes said list as an enabling consumer business model to enabled to all participants to inter collaborate concentrically and vertically with and by all customers and consumers centered accessed to and surrounded by all other enabling components.
(d) Software process comprising customers and consumers of businesses and organizations.
(e) A method for an enabling consumer business model to obtain and arrange within an organization the customer consumer data comprising; within this unique structure communication and data exchanged is selectable and adjustable with all components, departments, and selectively enabled access with all centered customers and consumers with said adjustable filtering data gateways.

4. Power and frequency transfer comprising balloons and apparatuses.
(a) a conductor comprising entries and exits balloon within any excess margins of fill tube device material.
(b) a conductor enters and exits balloon at or in seams
(c) a balloon comprising sealing 2 or more sections of balloon material comprised of seams include passage sealed through for one or more conductors or other devices and applications.
(d) a foil balloon sides at the sealed edges can be folded back through the edges when sealed to provide same conducting surface as a conductor inside a balloon.
(e) a conductor material comprises as antenna or antenna material and means of locating.
(f) a conductor comprising of one or more conductive material located on balloon material.
(g) transparent conductors comprising needs for capacitive touch sensors on balloon or apparatuses.
(h) a conductor comprising of 1 or more seam margins of material or seam margin as carrier for conductor and when folded back and sealed internally.
(i) a conductor as part of or located in comprising 1 or more seam margins of material and 1 or more seams marginally apart.

5. The said balloons and apparatus comprising power and frequencies comprised of printed, etched batteries, components, circuits, magnetics, memory, logic, signals, software and data.

6. The signal frequencies comprising remote infrared transmits to receiver to actuator to device or transmitter inside balloon resulting in desired outcomes.

7. The apparatus comprising of balloons, light weight toys, sensors with magnetically attracted surfaces mounting to balloon by magnetic attraction through balloon surface comprising:
(a) a magnetic material comprising an attachment to inside wall of balloon.
(b) an apparatus outside of balloon attached with magnetic material.
(c) said apparatus with magnet material attached placed next to outer balloon surface that is backed inside with said magnetic material surface.
(d) directly over inside attached magnetic material is attached outside a matching attached magnetic material.
(e) said magnetic material attached to outside wall of balloon

8. The said lighter than air inflated balloon achieving neutral buoyancy with weight adjustable printed material comprising apparatus to utilize the effect of drafting. Said thin light weight material in sizes appropriate for size and weight of balloons. Attached to outside of balloon surface to increase balloon overall surface area to increase lift and speed as effected by drafts.
